(19) United States
(12) Patent Application Publication
(10) Pub. No.: US 2023/0419659 A1
(43) Pub. Date: Dec. 28, 2023

(54) METHOD AND SYSTEM FOR PROCESSING POINT-CLOUD DATA

(71) Applicant: Sharper Shape Oy, Espoo (FI)

(72) Inventors: Jaro Uljanovs, Espoo (FI); Vlad Serkov, Espoo (FI)

(73) Assignee: Sharper Shape Oy, Espoo (FI)

(21) Appl. No.: 17/847,870

(22) Filed: Jun. 23, 2022

(51) Int. Cl. G06V 20/10; G06T 7/11; G06V 10/774; G06V 10/764; G06V 10/82; G06V 10/36; G06V 10/32; G06T 7/62; G06V 10/94; G01S 17/89

(52) U.S. Cl. CPC G06V 20/176; G06T 7/11; G06V 10/774; G06V 10/764; G06V 10/82; G06V 10/36; G06V 10/32; G06T 7/62; G06V 10/955; G01S 17/89; G06T 2207/20021; G06T 2207/20081; G06T 2207/20084; G06T 2207/10028; G06T 2207/20076

(57) ABSTRACT

A method and a system for processing a point-cloud data. The method includes splitting the point-cloud data into a training dataset and a test dataset; segmenting the point-cloud data in the training dataset to define a plurality of point-cloud data tiles corresponding to an area of predetermined size; sampling the plurality of point-cloud data tiles to select the point-cloud data tiles including at least one data point corresponding to one or more predefined classes; dividing each of the selected point-cloud data tiles into a plurality of voxels of a predetermined volume; filtering a data point from each of the plurality of voxels having a lowest value for corresponding pulse returns ratio; normalizing the point-cloud data tiles with the filtered data points; and implementing the normalized point-cloud data tiles in a graph neural network for training thereof.

### TECHNICAL FIELD

The present disclosure relates to processing of point-cloud data; and more specifically to systems and methods for processing a point-cloud data, generated using reflected pulses based on a remote sensing technique, of a geographical region comprising electrical utility components installed therein.

### BACKGROUND

Generally, since the advent of imaging devices, visual information of the real world i.e., the three-dimensional (3D) world has been conventionally projected onto two dimensional (2D) images. However, such conventional images do not indicate aspects such as, but not limited to, depth information and the relative positioning information between any two objects in reality and as such, renders the 2D images unsuitable for applications requiring such aspects such as, robotics, autonomous driving, virtual reality (VR), augmented reality (AR), Mixed Reality (XR) and so forth.

Conventionally, to overcome such a problem, the use of stereo vision was implemented, wherein two or more cameras were used to extract 3D information. However, such a method is both resource intensive and time consuming. Thus, to effectively solve the aforementioned problems, point-cloud datasets are employed to visually depict the three-dimensional information. The term “point-cloud data” refers to an unstructured dataset configured for representation of virtual 3D objects, usually obtained by some form of 3D scanning or imaging devices. Typically, each point in the cloud contains corresponding cartesian coordinates (i.e., X, Y, Z positions) and belongs to a surface of the object of interest, probably with some added noise. Moreover, with the increasing availability of sensing devices such as, light detection and ranging devices (LiDAR), smartphones, other imaging devices configured for capturing 3-dimensional information of the object(s) of interest, the use of point-cloud data has been increasing rapidly.

While deep learning on 3D point-cloud datasets have shown a good performance on several tasks, including classification, parts, and segmentation; however, there still exists a significant problem of scaling to a larger area (such as, across a state, or a country), which remains largely unexploited as most of the current works rely on cutting large scenes into smaller pieces. Further, the storage and processing of point-cloud datasets is extremely difficult owing to the huge size and computational requirements for training the datasets. In an exemplary scenario, merely tiling a sample dataset such as, a 100×100 meter (m) tile size would result in large data objects having a size of 270 megabytes (MB) when uncompressed prior to any filtering or further tiling. It may be appreciated that the whole dataset may contain about 1450-1600 km of powerline corridor with a width of the order of 100 m. Herein, iterating through over 1000 km of captured LiDAR corridor data would take several months at current dataset size, with insufficient batch size to allow for improved generalization owing to batch normalization. With the current dataset size in km, and tile size in MB, the processing of such point-cloud data is not feasible. Moreover, the additional requirement of augmentation would further increase training time on point-cloud data (approximately, twice the original time taken), but it is however necessary to perform in order to improve the final result accuracy.

Therefore, in light of the foregoing discussion, there exists a need to overcome the aforementioned drawbacks and provide an improved system or method for processing the point-cloud data.

### SUMMARY

The present disclosure seeks to provide a method and a system for processing a point-cloud data, generated using reflected pulses based on a remote sensing technique, of a geographical region comprising electrical utility components installed therein. An aim of the present disclosure is to provide a solution that overcomes at least partially the problems encountered in prior art.

In one aspect, an embodiment of the present disclosure provides a method for processing a point-cloud data, generated using reflected pulses based on a remote sensing technique, of a geographical region comprising electrical utility components installed therein, the method comprising:
splitting the point-cloud data into a training dataset and a test dataset;
segmenting the point-cloud data in the training dataset to define a plurality of point-cloud data tiles, with each of the plurality of point-cloud data tiles comprising the point-cloud data corresponding to an area of a predetermined size of the geographical region point-cloud data tiles;
sampling the plurality of point-cloud data tiles based on one or more predefined classes associated with the electrical utility components, to select the point-cloud data tiles, from the plurality of point-cloud data tiles, comprising at least one data point corresponding to the one or more predefined classes;
dividing each of the selected point-cloud data tiles into a plurality of voxels of a predetermined volume;
filtering a data point from each of the plurality of voxels having a lowest value for corresponding ratio of actual number of pulse returns to total number of pulse returns;
normalizing the point-cloud data tiles with the filtered data points, to reduce number of data points in each of the point-cloud data tiles up to an optimal number; and
implementing the normalized point-cloud data tiles in a graph neural network for training thereof, such that the trained graph neural network is utilized for processing of the point-cloud data.

In another aspect, the present disclosure also provides a system for processing a point-cloud data, generated using reflected pulses based on a remote sensing technique, of a geographical region comprising electrical utility components installed therein, the system comprising:
a memory configured to store the point-cloud data;
a graph neural network; and
a processing arrangement in signal communication with the memory and the graph neural network, the processing arrangement configured to:
   split the point-cloud data into a training dataset and a test dataset;
   segment the point-cloud data in the training dataset to define a plurality of point-cloud data tiles, with each of the plurality of point-cloud data tiles comprising the point-cloud data corresponding to an area of a predetermined size of the geographical region point-cloud data tiles;
   sample the plurality of point-cloud data tiles based on one or more predefined classes associated with the electrical utility components, to select the point-cloud data tiles, from the plurality of point-cloud data tiles, comprising at least one data point corresponding to the one or more predefined classes;
   divide each of the selected point-cloud data tiles into a plurality of voxels of a predetermined volume;
   filter a data point from each of the plurality of voxels having a lowest value for corresponding ratio of actual number of pulse returns to total number of pulse returns;
   normalize the point-cloud data tiles with the filtered data points, to reduce number of data points in each of the point-cloud data tiles up to an optimal number; and
   implement the normalized point-cloud data tiles in the graph neural network for training thereof, such that the trained graph neural network is utilized for processing of the point-cloud data.

Embodiments of the present disclosure substantially eliminate or at least partially address the aforementioned problems in the prior art and enable the system or method for optimizing image data for generating orthorectified image(s) related to an area of interest in an environment.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method for processing a point-cloud data, generated using reflected pulses based on a remote sensing technique, of a geographical region comprising electrical utility components installed therein, in accordance with an embodiment of the present disclosure;

FIG. 2 is a block diagram of a system for processing a point-cloud data, generated using reflected pulses based on a remote sensing technique, of a geographical region comprising electrical utility components installed therein, in accordance with an embodiment of the present disclosure;

FIG. 3A is a diagrammatic illustration of an exemplary working environment for an aerial vehicle capturing image data for generating the point-cloud data and corresponding graphical illustration representing the plurality of point-cloud data tiles, in accordance with one or more embodiments of the present disclosure;

FIG. 3B is a flowchart listing steps involved in a sampling process implemented via the method of FIG. 1, in accordance with one or more embodiments of the present disclosure;

FIG. 3C is an exemplary diagrammatic view of a filtering step implemented via the method of FIG. 1, in accordance with one or more embodiments of the present disclosure; and

FIG. 3D is an exemplary graphical view of a voxel representing a filtering step implemented via the method as described in FIG. 3C, in accordance with one or more embodiments of the present disclosure

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In an aspect, an embodiment of the present disclosure provides a method for processing a point-cloud data, generated using reflected pulses based on a remote sensing technique, of a geographical region comprising electrical utility components installed therein, the method comprising:
splitting the point-cloud data into a training dataset and a test dataset;
segmenting the point-cloud data in the training dataset to define a plurality of point-cloud data tiles, with each of the plurality of point-cloud data tiles comprising the point-cloud data corresponding to an area of a predetermined size of the geographical region point-cloud data tiles;
sampling the plurality of point-cloud data tiles based on one or more predefined classes associated with the electrical utility components, to select the point-cloud data tiles, from the plurality of point-cloud data tiles, comprising at least one data point corresponding to the one or more predefined classes;
dividing each of the selected point-cloud data tiles into a plurality of voxels of a predetermined volume;
filtering a data point from each of the plurality of voxels having a lowest value for corresponding ratio of actual number of pulse returns to total number of pulse returns;
normalizing the point-cloud data tiles with the filtered data points, to reduce number of data points in each of the point-cloud data tiles up to an optimal number; and
implementing the normalized point-cloud data tiles in a graph neural network for training thereof, such that the trained graph neural network is utilized for processing of the point-cloud data.

In another aspect, an embodiment of the present disclosure provides a system for processing a point-cloud data, generated using reflected pulses based on a remote sensing technique, of a geographical region comprising electrical utility components installed therein, the system comprising:
a memory configured to store the point-cloud data;
a graph neural network; and
a processing arrangement in signal communication with the memory and the graph neural network, the processing arrangement configured to:
   split the point-cloud data into a training dataset and a test dataset;
   segment the point-cloud data in the training dataset to define a plurality of point-cloud data tiles, with each of the plurality of point-cloud data tiles comprising the point-cloud data corresponding to an area of a predetermined size of the geographical region point-cloud data tiles;
   sample the plurality of point-cloud data tiles based on one or more predefined classes associated with the electrical utility components, to select the point-cloud data tiles, from the plurality of point-cloud data tiles, comprising at least one data point corresponding to the one or more predefined classes;
   divide each of the selected point-cloud data tiles into a plurality of voxels of a predetermined volume;
   filter a data point from each of the plurality of voxels having a lowest value for corresponding ratio of actual number of pulse returns to total number of pulse returns;
   normalize the point-cloud data tiles with the filtered data points, to reduce number of data points in each of the point-cloud data tiles up to an optimal number; and
   implement the normalized point-cloud data tiles in the graph neural network for training thereof, such that the trained graph neural network is utilized for processing of the point-cloud data.

The present disclosure provides a method for processing a point-cloud data, generated using reflected pulses based on a remote sensing technique, of a geographical region comprising electrical utility components installed therein. The point-cloud data is generated using reflected pulses based on a remote sensing technique implemented for a geographical region of interest having utility components installed therein. Herein, the “remote sensing technique” refers to a type of sensing technique configured for sensing and/or detecting one or more objects present in the geographical region. Beneficially, the remote sensing techniques provide data collection for relatively large geographical regions such as, of the order of 100 kilometres (km) in a quick and efficient manner. The present method may employ any of the two types of remote sensing techniques, namely active and/or passive sensing techniques (or devices or systems) that may be employed for a variety of purposes. The active sensing techniques comprise LiDAR sensing, Radar sensing such as, Interferometric synthetic aperture radar (InSAR), Synthetic Aperture Radar (SAR), etc., whereas passive sensing techniques comprise aerial photography, hyperspectral imaging, Satellite imaging, multi-spectral imaging and so forth. In general, the present method utilizes the reflected pulses (from the object(s)) based on the remote sensing technique to generate the point-cloud data.

It may be appreciated that the storage and processing of point-cloud datasets is extremely difficult owing to the huge size and computational requirements for training the datasets in a timely manner. In an exemplary scenario, merely tiling a sample dataset such as, a 100×100 metres (m) tile size would result in large data objects having a size of 270 megabytes (MB) when uncompressed prior to any filtering or further tiling, while the whole dataset may contain about 1450-1600 km of powerline corridor with a width of the order of 100 m. Thus, in order optimize the implementation via Batch Normalisation within the Graph Neural Network, maximum number of training datasets (or graphs) are provided to the GPU, vRAM simultaneously while training the neural network. Additionally, the neural network is required to be able to learn from as much training data as possible, wherein iterating through over 1000 km of captured LiDAR corridor would take several months at current dataset size, with insufficient batch size to allow for improved generalization owing to batch normalisation. With the current dataset size in km, and tile size in MB, this is not feasible. Thus, pre-processing techniques are needed in order to elevate the problem. The addition of augmentation would further increase training time on point-cloud data (approximately twice the original time taken), but it is necessary to improve the final result accuracy. Therefore, in light of the aforementioned problems, a pre-processing method and/or system is required for the effective and efficient processing of large point-cloud datasets.

In order to solve the aforementioned problems, in the present method for processing the point-cloud data, large point-cloud datasets are tiled into smaller point-cloud tiles and thereafter a sampling algorithm is implemented on each tile, which is randomly initialized each time a given tile is trained upon. Notably, the method is focused on points of interest type of data (i.e., irrelevant data is not analysed/processed) and thus, makes the present method more effective owing to the lesser memory and power consumption. Beneficially, such a method provides a novel augmented tile each time the tile is sampled, which is smaller in size. Moreover, in combination with the tiling of the point-cloud datasets, the choice of sampling algorithm further improves the efficiency of the method, wherein the method may employ a Farthest-Point-Sampling (FPS) filter to enable even faster sampling on a GPU (Graphics Processing Unit).

The method comprises splitting the point-cloud data into a training dataset and a test dataset. That is, upon generating the point-cloud data using the reflected pulses based on the remote sensing technique (for example, LiDAR sensing employed for sensing a geographical region of an electrical corridor spanning over 1000 Km), the point-cloud data generated using the remote sensing technique is split into two distinct datasets i.e., the training dataset and the test dataset, for training a graph neural network (GNN). The splitting operation is done at an early stage to ensure that each part of the split has a variety of different geographical areas, wherein the test dataset may consist of a pre-defined percentage (such as, 5%, 10%, 15%, 20%, etc.) of the total collected datasets (that may occupy petabytes of data). Herein, the sample size of the test data set may be smaller (such as, 1%, 2%, 3%, 5%, 7%, 10%, 15%, etc.) than the usual 80/20 train/test split (which is typically based on the pareto principle) owing to the large amount of training data to beneficially reduce the size of the overall dataset to be processed and thereby improves the efficiency of the method. Herein, the pre-defined percentage of the entire point-cloud dataset are selected at random, such that a corresponding pre-defined percentage of the geographical region or areas (i.e., the large datasets) are used for testing, wherein selecting totally different (or random) geographical regions or areas into the test set makes the testing un-biased and more reliable (i.e., the network does not overfit to the areas or regions provided during training).

In an embodiment, the method further comprises splitting the point-cloud data with a ratio of 10:90 for the training dataset and the test dataset, respectively. Typically, the splitting of the point-cloud data is done with a ratio of 10:90 for the training dataset and the test dataset, respectively. Alternatively stated, the pre-defined percentage is 10%. Thus, 10% sample size of the entire point-cloud data (or the test dataset) (i.e., smaller than the usual 80/20 train/test split, as based on the pareto principle) is used, owing to the large amount of training data to beneficially reduce the size of the overall dataset to be processed via the present method. Herein, 10% of the entire point-cloud dataset are selected at random, such that 10% of the geographical region or areas (i.e., the large datasets) are used for testing, wherein selecting totally different geographical regions or areas into the test set makes the testing unbiased and more reliable (i.e., the network does not overfit to the areas given in training). In an example, when a 1000 km flight has taken place, 10% of the total data collected i.e., equivalent to a 100 km length is used as the test dataset, wherein a typical flight height of about 30 m, results in a point-cloud size of 100 km wide and 30 m height.

In an embodiment, the method further comprises splitting the point-cloud data based on the geographical region, such that the training dataset comprises the point-cloud data representative of the geographical region. That is, the method may be further configured to split the point-cloud data based on the geographical region i.e., representative of the geographical region. In an exemplary scenario, the method may be configured to split the point-cloud data such as, a first geographical region (for example, having a region of 100 km) which may represent a particular defined sector or region, a second geographical region (for example, having a region of 200 km) which may represent another defined sector, such that the point-cloud data to be processed may be identified by the geographical region and thereby makes the processing simpler and faster.

The method further comprises segmenting the point-cloud data in the training dataset to define a plurality of point-cloud data tiles, with each of the plurality of point-cloud data tiles comprising the point-cloud data corresponding to an area of a predetermined size of the geographical region point-cloud data tiles. That is, upon splitting the point-cloud data, the method includes segmenting the point-cloud data of the training dataset to define the plurality of point-cloud data tiles, wherein each of the point-cloud data tiles correspond to an area of a predetermined size. Herein, the term “segmenting” refers to the process of grouping of points into homogenous regions such as, based on edges, orientation, or surface properties. The term “point-cloud data tiles” may be defined as the segmented point-cloud data of the training data set corresponding to an area (such as, of a geographical region) of the predetermined size. For example, the predetermined area size may be 5 m×10 m×10 m, 15 m×15 m, 20 m×20 m, 30 m×30 m, and so forth. It will be appreciated that the predetermined size of the point-cloud data tiles may vary depending upon the implementation to beneficially improve the efficiency of the present method. Notably, since the point-cloud data are generally large sized datasets, thus processing the entire dataset at each instance would consume a lot of time and resources, and may not always be required to process the entire dataset, thus segmentation of the point-cloud data allows usage and/or processing of a portion of the entire dataset and thereby saving associated time and resources. Additionally, the segmentation of the point-cloud-data into the plurality of tiles enables the method to perform the computation of the tiles in a parallel manner (i.e., parallel processing) to further reduce the corresponding computational time and resources and thereby improving the efficiency of the method

In one or more embodiments, the method further comprises defining each of the point-cloud data tiles to be of the predetermined size with a length and a width, and with a buffer of up to 50% in either direction for at least one of the length and the width of the predetermined size, by utilizing a sliding window technique. That is, in order to efficiently capture the geographical region via the remote sensing technique, the method may be further configured to define each of the point-cloud data tiles to be of the predetermined size having the length and width, wherein the method allows for a buffer of up to 50% in either direction for at least one of the length and/or the width of the predetermined size by utilizing the sliding window technique to effectively process the entire point-cloud dataset by efficiently identifying or classifying the object(s) and capturing the spatial relationships therebetween. Herein, in an exemplary scenario of an electrical corridor, in order to capture the powerlines and towers while maintaining a small size (approximately, 10 megabytes (MB) at full density per tile), the predetermined size of 10 m×10 m was selected (since, training tests with 5 m and 20 m sizes resulted in deteriorated results), with a 5 m buffer (i.e., 50% of the width or length) in each direction such that no geographical relations are lost when training on the point-cloud-data. Further, the sliding window approach is adopted for capturing all spatial relationships within the point-cloud-data which fall within the 10 m range in the dataset. Notably, the 10 m×10 m tile configuration is more accurate than corresponding to 5×5 m and 20×20 m tiles, in terms of final accuracy and thus improves the efficiency of the method.

The method further comprises sampling the plurality of point-cloud data tiles based on one or more predefined classes associated with the electrical utility components, to select the point-cloud data tiles, from the plurality of point-cloud data tiles, comprising at least one data point corresponding to the one or more predefined classes. That is, upon segmenting the point-cloud data into the plurality of tiles, the method includes sampling the plurality of tiles in a defined order to address the point-wise class imbalance within the data. Herein, the term “predefined classes” refer to the set of pre-identified configurations based on which point-cloud data tiles are sampled and thereby classified. It may be understood that only the one or more pre-defined classes are of interest and are required to be monitored such as most electrical utility components including, but not limited to, various types of wires, electric poles, towers, etc. and thus, the increasing number of such points of interest in a given tile of the plurality of tiles, makes the given tile increasingly relevant. Typically, if there is at least one such point in the given tile, then the given tile is selected for training via the method. Alternatively stated, only the tiles of interest i.e., the tiles containing at least one such point (for example, comprising interested elements like poles, towers etc.) are selected for training, whereas other non-interesting tiles (for example, comprising trees and vegetation) are dropped or not selected. Such an implementation significantly reduces the size of the overall dataset and thereby improves the computational efficiency of the method. Since, generally, there are far more non-interesting elements (such as, vegetation, ground, other non-interesting points) in comparison to interesting elements (such as, electrical utility components such as, poles or conductor wire points within the dataset) and as result, the capture of such geographical regions occupy a lot of unnecessary data. Thus, for addressing the aforementioned problem, the method includes checking for relevant and infrequently occurring classes in the tile (such as, powerlines, poles or towers, etc.) and ensuring that the tiles, wherein such classes occur, are always kept for training; while, allowing less important tiles (such as, only vegetation, ground, building, or any other) to be kept with a defined probability range or limit. Herein, there are some tiles without any prioritised classes and the classifier doesn't always assume that there must be a point of interest (such as, conductor/pole/etc.) within each tile. Beneficially, such an implementation significantly improves the speed and efficiency of the method by reducing the memory occupied by the irrelevant dataset; that is the memory reduction is achieved by keeping only the tiles containing the classes of interest upon tiling.

In one or more embodiments, selecting the point-cloud data tiles from the sampled point-cloud data tiles further comprises selecting the point-cloud data tiles with at least a 1% probability of having the at least one data point corresponding to the one or more predefined classes. Typically, for selecting the point-cloud data tiles from the sampled point-cloud data tiles, the method involves checking each of the point-cloud data tiles to select the point-cloud data tiles having at least a 1% probability of having at least one data point corresponding to the one or more pre-defined classes. Since, the point-cloud data comprises a significant portion of non-interesting elements that are not required to be processed, thus to effectively remove the non-interesting elements while maintaining the accuracy of the method, the method includes checking for relevant and infrequently occurring classes in the tile (such as, powerlines, poles or towers, etc.) and ensuring that the tiles wherein such classes occur are always kept for training, while allowing less important tiles (such as, only vegetation, ground, building, or any other) to be kept with a probability of 1%. Hence, there are some tiles without any prioritised classes and the classifier doesn't always assume that there must be a point of interest (such as, conductor, pole, etc.) within each tile. Alternatively stated, such an implementation significantly improves the speed by reducing the memory occupied by the irrelevant datasets i.e., the memory reduction is achieved by keeping only the tiles containing the one or more predefined classes (of interest) upon tiling.

The method further comprises dividing each of the selected point-cloud data tiles into a plurality of voxels of a predetermined volume. That is, upon sampling the plurality of point-cloud data tiles based on the one or more pre-defined classes, the method includes dividing each of the selected point-cloud data tiles into a plurality of voxels having a predetermined volume. The “voxel” refers to a unit of graphical information defining a point in a three-dimensional space of the point-cloud data and represents a value (such as, location) in the three-dimensional space. Typically, each of the plurality of point-cloud data tiles are divided, based on the one or more pre-defined classes, into the plurality of voxels having a predetermined volume that may be varied based on the implementation. In an example, each voxel may have a volume of 125 cm³ (cubic-centimetres). In another example, each voxel may have a volume of 1000 cm³. It will be appreciated that each of the one or more predefined classes may have a corresponding predetermined value defining the plurality of voxels. For example, the method includes selecting a pre-determined volume of 8000 cm³ for one of the one or more pre-defined classes indicative of an electric tower. Beneficially, dividing each of the selected point-cloud data tiles into a plurality of voxels of a predetermined volume is used to reduce memory consumption and to improve system performance.

The method further comprises filtering a data point from each of the plurality of voxels having a lowest value for corresponding ratio of actual number of pulse returns to total number of pulse returns. That is, upon dividing each of the plurality of tiles into the plurality of voxels, the method includes filtering a data point from each of the plurality of voxels that has the lowest value for corresponding ratio of actual number of pulse returns to total number of pulse returns. Typically, the reflected pulses based on the remote sensing technique are monitored to determine the ratio of actual number of pulse returns to total number of pulse returns based on which the data point having the lowest value may be filtered. Herein, the method includes comparing the ratio of actual and total pulse returns, and selecting the data point having the lowest ratio i.e., lowest actual number of pulse returns out of the total number of pulse returns (since, upon being reflected back to the remote sensor, the returned pulse was not fully absorbed and hence it comprises multiple total returns, due to the thinness of the structure). Beneficially, such a filtering step reduces the point-cloud density and preferentially keeps the points within each voxel that are more likely to represent the one or more predefined classes (such as, the poles, wire structures, etc.) and thus, reduces the overall point-cloud data to be processed and thereby improves the efficiency of the method.

In one or more embodiments, the method further comprises defining the predetermined volume for each of the plurality of voxels to be 15-25 cm×15-cm×15-25 cm, to have a data point density per voxel from 0.001 to 0.016 m³ (cubic-meter). Typically, before training via the method or processing the point-cloud, the density of the points within the point-cloud dataset (or point-cloud density) and the volume of each of the plurality of voxels may be varied based on the implementation. As used herein, the “point-cloud density” refers to an indicator of the resolution of the point-cloud data, wherein a higher point density means more information (i.e., high resolution) while lower density means less information (i.e., low resolution). Thus, upon experimentation and analysis, the volume of each of the voxels is predetermined to be defined in a range between 15 cm to 25 cm (length) by 15 cm to 25 cm (width) by 15 cm to 25 cm (height) i.e., in a range between 3375 cm³ and 15625 cm³. In an example, the predetermined volume of each of the plurality of voxels is 20 cm×20 cm×20 cm i.e., 8000 cm³ and the data point density per voxel varies from 0.001 to 0.016 m³. Beneficially, defining the predetermined volume for each of the plurality of voxels is used to reduce memory consumption and to improve system performance.

The method further comprises normalizing the point-cloud data tiles with the filtered data points, to reduce number of data points in each of the point-cloud data tiles up to an optimal number. That is, upon filtering the data point from each of the plurality of voxels, the method includes normalizing the point-cloud data tiles with the filtered data points to reduce the number of data points in each point-cloud data tiles to the optimal number and thereby standardize the input point-cloud data. As used herein, the “optimal number” refers to a number of data points in each point-cloud data tiles that enable an optimal normalization operation i.e., removes any stability issues during batch normalization. In one or more embodiments, the optimal number is between 2047 and 8193. For example, the optimal number may be 2048, 4196, 8192, and so forth. Beneficially, normalizing the point-cloud data tiles with the filtered data points reduces the number of data points to be processed in the point-cloud data tiles up to an optimal number, and thus, improves the efficiency of the system while maintaining the accuracy.

In one or more embodiments, the method further comprises normalizing the point-cloud data tiles using a Farthest Point Sampling (FPS) filter. That is, the method includes normalizing the point-cloud data tiles by sampling the point-cloud data tiles to beneficially reduce the resolution of points across layers. As discussed, the point-cloud data tiles of a predetermined size (such as, 10 m×20 m and a buffer of 50% i.e., 5 m) having the predefined point-cloud density (such as, 0.008 m³ per voxel) is utilized, and herein normalized using the FPS filter; wherein if M points are sampled, then each point is selected based on the most distance from the rest of the M−1 points in the point-cloud data tiles. Herein, the filtering may be done on-line or “on-the-fly” while the network is training. Since, FPS filtering is randomly initiated, every new epoch (period) would be slightly different, as a different set of 4096 points is sampled from the original tile. Beneficially, the 20 m×20 m ((5+10+5)×(5+10+5)) point-cloud data tiles with a density of one point per 0.008 m³ voxel are filtered using the FPS algorithm, to normalise and reduce the number of points in each tile to 4096 points or fewer (in case, the original tile already contains fewer points). Notably, upon further analysis and experimentation of the FPS parameters, no significant effect in increasing the number of points (i.e., from 4096 to 8192) may be noticed, while the results may deteriorate by reducing the number of points (i.e., from 4096 to 2048), and as a result, 4096 is selected as the optimal number. Beneficially, such an implementation of the FPS filter via the method results in a more efficient method since the point-cloud data tiles are quickly sampled via increased GPU acceleration, and thus, novel set of points are obtained for each training epoch, while managing the size constraint.

The method further comprises implementing the normalized point-cloud data tiles in a graph neural network for training thereof, such that the trained graph neural network is utilized for processing of the point-cloud data. That is, upon normalizing the point-cloud data tiles, the method includes implementing the normalized point-cloud data tiles in the GNN for training thereof and thereby efficiently and effectively processing the point-cloud data. In one or more embodiments, the training of the graph neural network is executed in a video RAM of a graphical processing unit. Beneficially, the execution of the graph neural network in the video RAM of the graphical processing unit in comparison to any conventional mass media storage improves the computational speed and enables the method to process the point-cloud data in a faster manner.

The present disclosure also relates to the system as described above. Various embodiments and variants disclosed above, with respect to the aforementioned first aspect, apply mutatis mutandis to the system.

In another aspect, the present disclosure also provides a system for processing a point-cloud data, generated using reflected pulses based on a remote sensing technique, of a geographical region comprising electrical utility components installed therein. Herein, the system is configured to process the point-cloud data, wherein the large point-cloud datasets are tiled into smaller point-cloud tiles and thereafter a sampling algorithm is implemented on each tile, which is randomly initialized each time a given tile is trained upon. Notably, the system is focused on points of interest type of data or defined by the one or more predefined classes (i.e., irrelevant data is not analysed or processed via the method) and thus, makes the method more efficient owing to the lesser memory and power consumptions. Beneficially, the system provides a novel augmented tile each time the tile is sampled, which is smaller in size. Moreover, in combination with the tiling of the point-cloud datasets, the choice of sampling algorithm may further improve the efficiency of the system, wherein the system may employ a Farthest-Point-Sampling (FPS) filter to enable even faster sampling on a Graphics Processing Unit (GPU).

The system comprises a memory configured to store the point-cloud data. Optionally, the memory is implemented as at least one database server. Optionally, the information pertaining to the power distribution infrastructure in the geographical region is stored at the memory. Optionally, the memory stores LiDAR and HSI databases of a plurality of geographical regions, and information pertaining to utility infrastructures in the plurality of geographical regions. Optionally, the memory is communicably coupled to the unmanned or manned aerial vehicles employed for capturing the image dataset corresponding to the point-cloud data. Optionally, the memory is communicably coupled to the unmanned aerial vehicles employed for capturing the information pertaining to the power distribution infrastructure in the geographical region. Optionally, the memory is communicably coupled to a device (such as, a computer or a server) associated with the power distribution infrastructure. Herein, the term “memory” refers to an organized body of digital information, regardless of the manner in which the point-cloud data or the organized body thereof is represented. Optionally, the memory may be hardware, software, firmware and/or any combination thereof. For example, the organized body of related image data may be in the form of a table, a map, a grid, a packet, a datagram, a file, a document, a list or in any other form. The memory includes any data storage software and systems, such as, for example, a relational database like IBM DB2 and Oracle 9. The said memory is operable to store the image data received from the data sources. Beneficially, the data collected in the memory is used by the system employing the one or more machine learning algorithms to identify non-interesting areas to down-sample or discard, to reduce the overall size of the image dataset and results in reduced memory consumption and associated storage costs.

The system further comprises a graph neural network (GNN). Typically, the system comprises the graph neural network configured for implementing the normalized point-cloud data for training thereof. Upon training the graph neural network, the GNN may thereby be used to efficiently and effectively process the point-cloud data and to enable the processing of the point-cloud data via the GNN. The system further comprises a processing arrangement in signal communication with the memory and the graph neural network. Throughout the present disclosure, the term “processing arrangement” refers to hardware, software, firmware, or a combination of these, for performing specialized data processing the point-cloud data, generated using reflected pulses based on the remote sensing technique, of the geographical region comprising electrical utility components installed therein. Optionally, the processing arrangement includes any arrangement of physical or virtual computational entities capable of enhancing information to perform various computational tasks. Further, it will be appreciated that the processing arrangement may be implemented as a hardware processor and/or plurality of hardware processors operating in a parallel or in a distributed architecture. Optionally, the processors in the processing arrangement are supplemented with additional computation system, such as neural networks, and hierarchical clusters of pseudo-analog variable state machines implementing artificial intelligence algorithms. In an example, the processing arrangement may include components such as a memory, a processor, a data communication interface, a network adapter and the like, to store, process and/or share information with other computing devices, such as the data source. Optionally, the processing arrangement includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit, for example as aforementioned. Additionally, the processing arrangement is arranged in various architectures for responding to and processing the instructions for creating training data for the graph neural network to the point-cloud data of the geographical region comprising electrical utility components installed therein. Optionally, the processing arrangement comprises a plurality of processors for parallel processing of the point-cloud image data tiles. Optionally, the processing arrangement is communicably coupled to the memory wirelessly and/or in a wired manner. Optionally, the processing arrangement is communicably coupled to the memory via a data communication network. It will be appreciated that the data communication network may be wired, wireless, or a combination thereof. Examples of the data communication network may include, but are not limited to, Internet, a local network (such as, a TCP/IP-based network, an Ethernet-based local area network, an Ethernet-based personal area network, a Wi-Fi network, and the like), Wide Area Networks (WANs), Metropolitan Area Networks (MANs), a telecommunication network, a radio network and Worldwide Interoperability for Microwave Access (WIMAX) networks.

Typically, the processing arrangement is configured to split the point-cloud data into a training dataset and a test dataset, segment the point-cloud data in the training dataset to define a plurality of point-cloud data tiles, with each of the plurality of point-cloud data tiles comprising the point-cloud data corresponding to an area of a predetermined size of the geographical region point-cloud data tiles. The processing arrangement is further configured to sample the plurality of point-cloud data tiles based on one or more predefined classes associated with the electrical utility components, to select the point-cloud data tiles, from the plurality of point-cloud data tiles, comprising at least one data point corresponding to the one or more predefined classes, divide each of the selected point-cloud data tiles into a plurality of voxels of a predetermined volume, filter a data point from each of the plurality of voxels having a lowest value for corresponding ratio of actual number of pulse returns to total number of pulse returns. The processing arrangement is further configured to normalize the point-cloud data tiles with the filtered data points, to reduce number of data points in each of the point-cloud data tiles up to an optimal number and implement the normalized point-cloud data tiles in the graph neural network for training thereof, such that the trained graph neural network is utilized for efficient processing of the point-cloud data.

In one or more embodiments, the processing arrangement is configured to split the point-cloud data based on the geographical region, such that the training dataset comprises the point-cloud data representative of the geographical region.

In one or more embodiments, the processing arrangement is configured to split the point-cloud data with a ratio of 10:90 for the training dataset and the test dataset, respectively.

In one or more embodiments, the processing arrangement is configured to define each of the point-cloud data tiles to be of the predetermined size with a length and a width, and with a buffer of up to 50% in either direction for at least one of the length and the width of the predetermined size, by utilizing a sliding window technique.

In one or more embodiments, the processing arrangement is configured to select the point-cloud data tiles from the sampled point-cloud data tiles by selecting the point-cloud data tiles with at least a 1% probability of having the at least one data point corresponding to the one or more predefined classes.

In one or more embodiments, the processing arrangement is configured to define the predetermined volume for each of the plurality of voxels to be 15-25 cm×15-25 cm×15-25 cm, to have a data point density per voxel of 0.001 to 0.016 m3.

In one or more embodiments, the processing arrangement is configured to normalize the point-cloud data tiles using a Farthest Point Sampling (FPS) filter.

In one or more embodiments, the optimal number is between 2047 and 8193.

In one or more embodiments, the system further comprises a graphical processing unit having a video RAM, wherein training of the graph neural network is executed in the video RAM of the graphical processing unit.

### DETAILED DESCRIPTION OF THE DRAWINGS

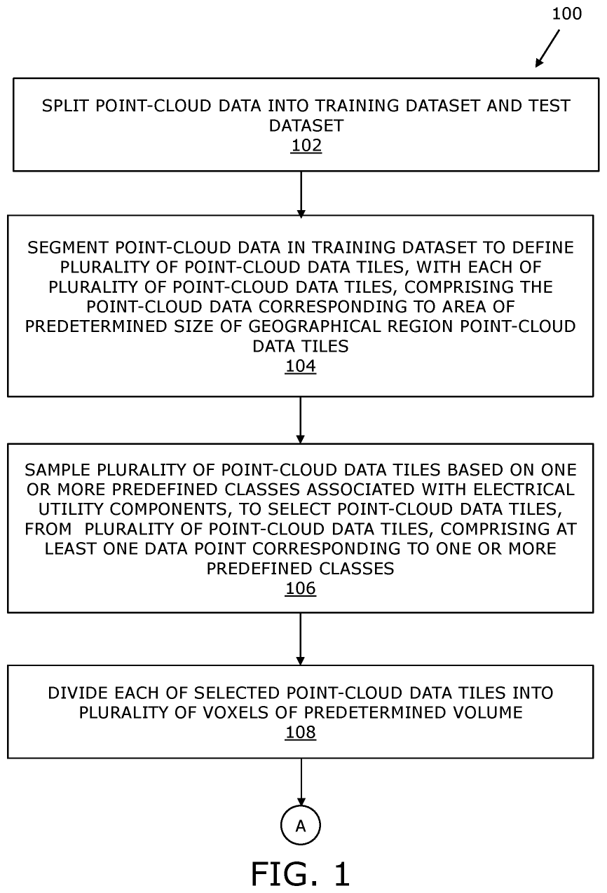

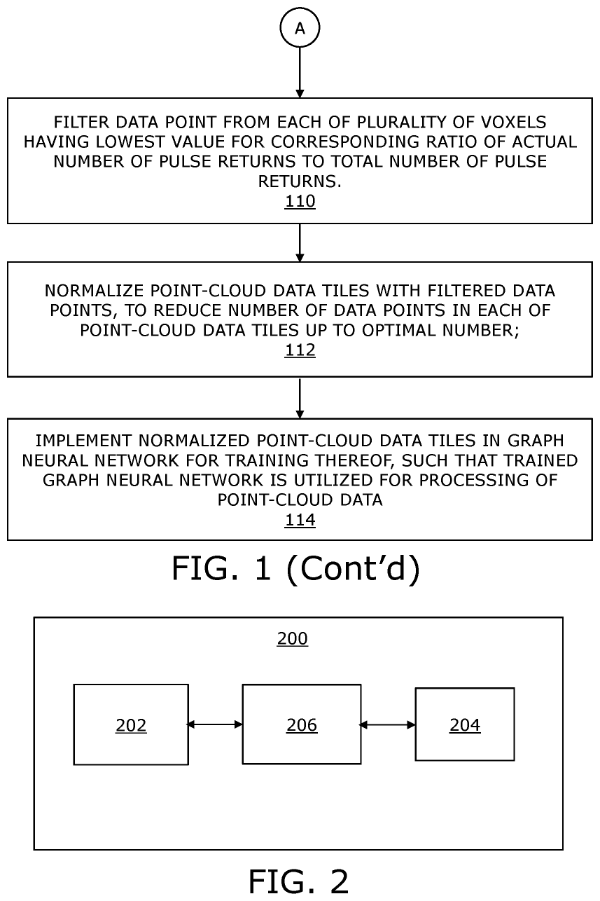

Referring to FIG. 1, illustrated is a flowchart listing steps involved in a method 100 for processing a point-cloud data, generated using reflected pulses based on a remote sensing technique, of a geographical region comprising electrical utility components installed therein, in accordance with an embodiment of the present disclosure. As shown, the method 100 comprises the steps 102, 104, 106, 108, 110, 112 and 114.

At a step 102, the method 100 comprises splitting the point-cloud data into a training dataset and a test dataset. Herein, upon generating the point-cloud data using reflected pulses based on the remote sensing technique, the method 100 includes splitting the generated point-cloud data into the training dataset and the test dataset, respectively.

At a step 104, the method 100 comprises segmenting the point-cloud data in the training dataset to define a plurality of point-cloud data tiles, with each of the plurality of point-cloud data tiles comprising the point-cloud data corresponding to an area of a predetermined size of the geographical region point-cloud data tiles. That is, upon splitting the point-cloud data, the method 100 includes segmenting the point-cloud data into a plurality of point-cloud data tiles based on predetermined size enabling further classification thereof.

At a step 106, the method 100 comprises sampling the plurality of point-cloud data tiles based on one or more predefined classes associated with the electrical utility components, to select the point-cloud data tiles, from the plurality of point-cloud data tiles, comprising at least one data point corresponding to the one or more predefined classes. That is, upon segmenting the point-cloud data into the plurality of point-cloud data tiles, the method 100 includes sampling each of the plurality of point-cloud data tiles based on one or more predefined classes associated with the electrical utility components, for identifying the interesting or relevant point-cloud data files required to be processed.

At a step 108, the method 100 comprises dividing each of the selected point-cloud data tiles into a plurality of voxels of a predetermined volume. That is, upon sampling the plurality of point-cloud data tiles, the method 100 includes dividing each of the selected point-cloud data sampled based on the one or more predefined classes into the plurality of voxels for further processing thereof.

At a step 110, the method 100 comprises filtering a data point from each of the plurality of voxels having a lowest value for corresponding ratio of actual number of pulse returns to total number of pulse returns. That is, upon dividing each of the selected point-cloud data tiles into the plurality of voxels having the predetermined volume, the method 100 includes filtering the voxel(s) having the lowest value of pulse return ratio, and thereby effectively identify the non-interesting voxels, and thus reduce the amount to point-cloud data to be processed. Optionally, the method 100 may employ an FPS filter to further increase the computation speed and enable faster sampling of the data in the implemented GPU.

At a step 112, the method 100 comprises normalizing the point-cloud data tiles with the filtered data points, to reduce number of data points in each of the point-cloud data tiles up to an optimal number. That is, upon filtering the data point in each of the plurality of voxels having the lowest value of pulse return ratio, the method 100 includes normalizing the point-cloud data tiles with the filtered data points, to reduce number of data points in each of the point-cloud data tiles and beneficially prevent any issues with GNN training stability during batch normalization.

And, at a step 114, the method 100 further comprises implementing the normalized point-cloud data tiles in a graph neural network for training thereof, such that the trained graph neural network is utilized for processing of the point-cloud data.

Referring to FIG. 2, illustrated is a block diagram of a system 200 for processing a point-cloud data, generated using reflected pulses based on a remote sensing technique, of a geographical region comprising electrical utility components installed therein, in accordance with an embodiment of the present disclosure. As shown, the system 200 comprises a memory 202 configured to store the point-cloud data, a graph neural network 204, and a processing arrangement 206 in signal communication with the memory 202 and the graph neural network 204. Herein, the processing arrangement 206 is configured to split the point-cloud data into a training dataset and a test dataset; segment the point-cloud data in the training dataset to define a plurality of point-cloud data tiles, with each of the plurality of point-cloud data tiles comprising the point-cloud data corresponding to an area of a predetermined size of the geographical region point-cloud data tiles; sample the plurality of point-cloud data tiles based on one or more predefined classes associated with the electrical utility components, to select the point-cloud data tiles, from the plurality of point-cloud data tiles, comprising at least one data point corresponding to the one or more predefined classes; divide each of the selected point-cloud data tiles into a plurality of voxels of a predetermined volume; filter a data point from each of the plurality of voxels having a lowest value for corresponding ratio of actual number of pulse returns to total number of pulse returns; normalize the point-cloud data tiles with the filtered data points, to reduce number of data points in each of the point-cloud data tiles up to an optimal number; and implement the normalized point-cloud data tiles in the graph neural network 204 for training thereof, such that the trained graph neural network 204 is utilized for processing of the point-cloud data.

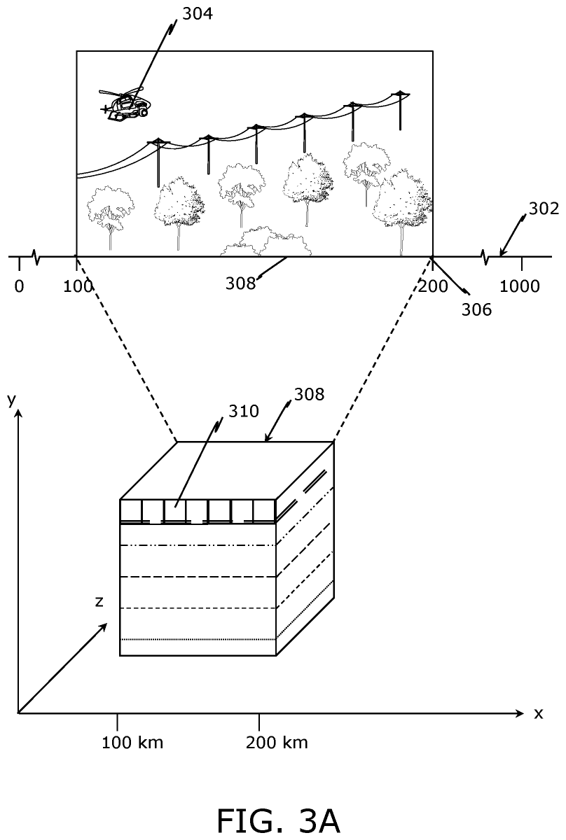

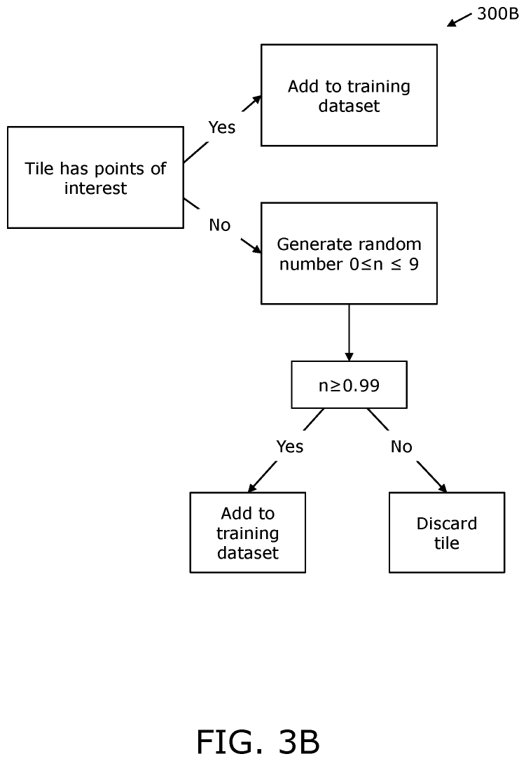

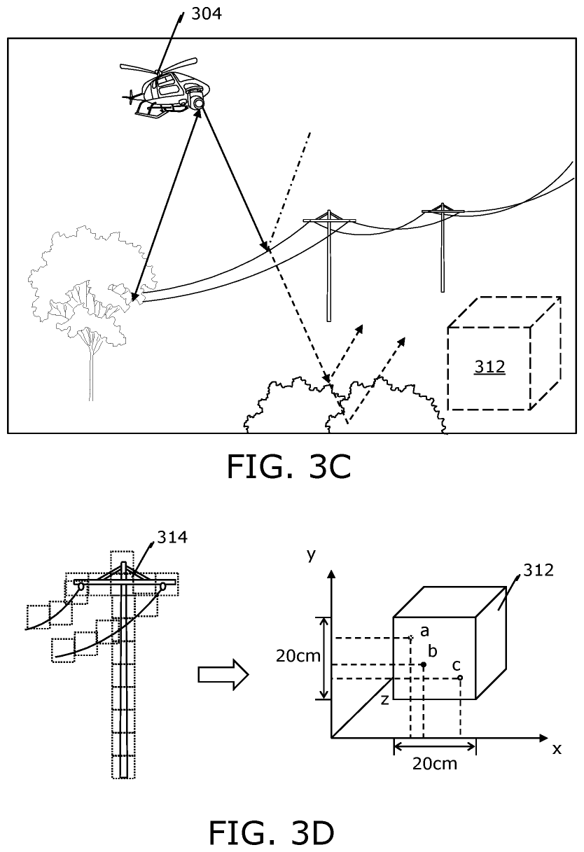

Referring to FIG. 3A to 3D, illustrated are depictions representing exemplary steps of the method 100 for processing a point-cloud data 302, generated using reflected pulses based on a remote sensing technique, of a geographical region comprising electrical utility components installed therein, in accordance with one or more embodiments of the present disclosure.

Referring to FIG. 3A, shown is a diagrammatic illustration of an exemplary working environment of an aerial vehicle configured for capturing image data for generating the point-cloud data and corresponding graphical illustration representing the plurality of point-cloud data tiles, in accordance with one or more embodiments of the present disclosure. FIG. 3A illustrates two distinct steps of the method 100, namely: splitting (i.e., step 102 of FIG. 1) of a point-cloud data 302 and tiling (i.e., step 104 of FIG. 1) of the point-cloud data 302. As shown, an aerial vehicle 304 utilizing the remote sensing technique (such as, LiDAR sensing, aerial photography, etc.) is configured to capture the image data of the geographical region (i.e., 1000 km) to generate the point-cloud data 302. As shown, in terms of the scale, the entire point-cloud data 302 is representative of a geographical region spanning over a 1000 km. Herein, at a first step, the method 100 comprises splitting the point-cloud data 302 into a training dataset 306 and a test dataset 308, respectively. The testing dataset 308 is selected as 10% of the entire point-cloud data i.e., 100 km and is randomly selected to avoid any potential bias or overfitting. Further, as shown, at a second step, the method 100 is further configured to segment the point-cloud data 302 into the plurality of point-cloud data tiles 310 based on predetermined size enabling further classification thereof. For example, the predetermined size has a length and a width of 10 m and 10 m, respectively.

Referring to FIG. 3B, illustrated is a flowchart listing steps involved in a sampling process 30013 implemented via the method 100, in accordance with one or more embodiments of the present disclosure. Herein, another step of the method 100 involving sampling (i.e., step 106 of FIG. 1) the plurality of point-cloud data tiles 310 based on one or more predefined classes associated with the electrical utility components, to select the point-cloud data tiles, from the plurality of point-cloud data tiles 310, comprising at least one data point corresponding to the one or more predefined classes is described. As shown, in the sampling process, the process involves checking for the tiles having the points of interest i.e., the tiles classified based on the one or more pre-defined classes (comprising the one or more electrical utility components). If the point of interest is present in any of the plurality of point-cloud data tiles 310, then it is selected for addition to the training dataset 306; otherwise, the method 100 is configured to determine a random number between (n), wherein if n is greater than 0.99, then the associated point-cloud data tile is added to the training dataset 306 or otherwise the associated tile is discarded in order to save space and improve the efficiency of the method.

Referring to FIG. 3C, illustrated is an exemplary diagrammatic view of a filtering step implemented via the method 100, in accordance with one or more embodiments of the present disclosure. As shown, the aerial vehicle 304 is employing the remote sensing technique by transmitting pulses towards the object(s) in the geographical region and based on the returned pulses received after reflection from the objects are thereby utilized to filter the data point from each of the plurality of voxels 312. That is, upon defining the plurality of voxels 312 to be of the predetermined volume (for example, 8000 cubic centimetres), the method 100, at the step 110, comprises filtering a data point from each of the plurality of voxels 312 having a lowest value for corresponding ratio of actual number of pulse returns to total number of pulse returns. Such a filtering step reduces the point-cloud density to 1 point per 8 cubic centimetres. It preferentially keeps those points within each 20 cm×20 cm×20 cm (8000 cubic centimetres) voxel which are more likely to represent a pole/wire structure. This involves comparing the ratio of actual return number and total number of returns for each of the plurality of voxels 312 and points therein, and selecting one (randomly, if many with same ratio exist) point which has the lowest return number out of total number of returns (i.e., it was reflected back to the aerial vehicle 304 or sensor first, but the pulse was not fully absorbed hence it has many total returns, due to thinness of the structure).

Referring to FIG. 3D, illustrated is an exemplary graphical view of a voxel 312 representing a filtering step as described in FIG. 3C, in accordance with one or more embodiments of the present disclosure. As shown, as an example, the electrical tower 314 may be defined by the plurality of voxels 312, wherein each point in the plurality of voxels may be processed to classify the voxel and the point-cloud data tile (of the plurality of point-cloud data tiles) containing the voxel 312 into the one or more predefined classes. In the illustrated example, point ‘a’ has 1 returned pulse out of 1 transmitted pulse, point ‘b’ has 1 returned pulse out of 7 transmitted pulses, and point ‘c’ has 1 returned pulse out of 5 transmitted pulses. As a result, the point ‘b’ may be filtered for the given voxel 312, as it has the smallest value of the pulse return ratio.

It may be understood by a person skilled in the art that the FIGS. 3A to 3D are merely examples for sake of clarity, which should not unduly limit the scope of the claims herein. The person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for processing a point-cloud data, generated using reflected pulses based on a remote sensing technique, of a geographical region comprising electrical utility components installed therein, the method comprising:
splitting the point-cloud data into a training dataset and a test dataset;
segmenting the point-cloud data in the training dataset to define a plurality of point-cloud data tiles, with each of the plurality of point-cloud data tiles comprising the point-cloud data corresponding to an area of a predetermined size of the geographical region point-cloud data tiles;
sampling the plurality of point-cloud data tiles based on one or more predefined classes associated with the electrical utility components, to select the point-cloud data tiles, from the plurality of point-cloud data tiles, comprising at least one data point corresponding to the one or more predefined classes;
dividing each of the selected point-cloud data tiles into a plurality of voxels of a predetermined volume;
filtering a data point from each of the plurality of voxels having a lowest value for corresponding ratio of actual number of pulse returns to total number of pulse returns;
normalizing the point-cloud data tiles with the filtered data points, to reduce number of data points in each of the point-cloud data tiles up to an optimal number; and
implementing the normalized point-cloud data tiles in a graph neural network for training thereof, such that the trained graph neural network is utilized for processing of the point-cloud data.

2. The method according to claim 1 further comprising splitting the point-cloud data based on the geographical region, such that the training dataset comprises the point-cloud data representative of the geographical region.

3. The method according to claim 1 further comprising splitting the point-cloud data with a ratio of 10:90 for the training dataset and the test dataset, respectively.

4. The method according to claim 1 further comprising defining each of the point-cloud data tiles to be of the predetermined size with a length and a width, and with a buffer of up to 50% in either direction for at least one of the length and the width of the predetermined size, by utilizing a sliding window technique.

5. The method according to claim 1, wherein selecting the point-cloud data tiles from the sampled point-cloud data tiles further comprises selecting the point-cloud data tiles with at least a 1% probability of having the at least one data point corresponding to the one or more predefined classes.

6. The method according to claim 1 further comprising defining the predetermined volume for each of the plurality of voxels to be 15-cm×15-25 cm×15-25 cm, to have a data point density per voxel from 0.001 to 0.016 m³.

7. The method according to claim 1 further comprising normalizing the point-cloud data tiles using a Farthest Point Sampling (FPS) filter.

8. The method according to claim 1, wherein the optimal number is between 33742047 and 84914 193.

9. The method according to claim 1, wherein training of the graph neural network is executed in a video RAM of a graphical processing unit.

10. A system for processing a point-cloud data, generated using reflected pulses based on a remote sensing technique, of a geographical region comprising electrical utility components installed therein, the system comprising:
a memory configured to store the point-cloud data;
a graph neural network; and
a processing arrangement in signal communication with the memory and the graph neural network, the processing arrangement configured to:
split the point-cloud data into a training dataset and a test dataset;
segment the point-cloud data in the training dataset to define a plurality of point-cloud data tiles, with each of the plurality of point-cloud data tiles comprising the point-cloud data corresponding to an area of a predetermined size of the geographical region point-cloud data tiles;
sample the plurality of point-cloud data tiles based on one or more predefined classes associated with the electrical utility components, to select the point-cloud data tiles, from the plurality of point-cloud data tiles, comprising at least one data point corresponding to the one or more predefined classes;
divide each of the selected point-cloud data tiles into a plurality of voxels of a predetermined volume;
filter a data point from each of the plurality of voxels having a lowest value for corresponding ratio of actual number of pulse returns to total number of pulse returns;
normalize the point-cloud data tiles with the filtered data points, to reduce number of data points in each of the point-cloud data tiles up to an optimal number; and
implement the normalized point-cloud data tiles in the graph neural network for training thereof, such that the trained graph neural network is utilized for processing of the point-cloud data.

11. The system according to claim 10, wherein the processing arrangement is configured to split the point-cloud data based on the geographical region, such that the training dataset comprises the point-cloud data representative of the geographical region.

12. The system according to claim 10, wherein the processing arrangement is configured to split the point-cloud data with a ratio of 10:90 for the training dataset and the test dataset, respectively.

13. The system according to claim 10, wherein the processing arrangement is configured to define each of the point-cloud data tiles to be of the predetermined size with a length and a width, and with a buffer of up to 50% in either direction for at least one of the length and the width of the predetermined size, by utilizing a sliding window technique.

14. The system according to claim 10, wherein the processing arrangement is configured to select the point-cloud data tiles from the sampled point-cloud data tiles by selecting the point-cloud data tiles with at least a 1% probability of having the at least one data point corresponding to the one or more predefined classes.

15. The system according to claim 10, wherein the processing arrangement is configured to define the predetermined volume for each of the plurality of voxels to be 15-25 cm×15-25 cm×15-25 cm, to have a data point density per voxel of 0.001 to 0.016 m³.

16. The system according to claim 10, wherein the processing arrangement is configured to normalize the point-cloud data tiles using a Farthest Point Sampling (FPS) filter.

17. The system according to claim 10, wherein the optimal number is between 33742047 and 4914 8193.

18. The system according to claim 10 further comprising a graphical processing unit having a video RAM, wherein training of the graph neural network is executed in the video RAM of the graphical processing unit.
